(19) United States
(12) Patent Application Publication
(10) Pub. No.: US 2026/0186190 A1
(43) Pub. Date: Jul. 2, 2026

(54) COUPLING-IN STRUCTURE, DIFFRACTIVE OPTICAL STRUCTURE, AND OPTICAL DISPLAY DEVICE

(71) Applicant: Goertek Optical Technology Co., Ltd., Weifang (CN)

(72) Inventors: Rudong Wei, Weifang (CN); Xin Cheng, Weifang (CN); Zhentao Fan, Weifang (CN)

(73) Assignee: Goertek Optical Technology Co., Ltd., Weifang (CN)

(21) Appl. No.: 19/404,838

(22) Filed: Dec. 1, 2025

(30) Foreign Application Priority Data
Dec. 31, 2024 (CN) 202411996420.X

(51) Int. Cl. F21V 8/00; G02B 5/18; G02B 27/01

(52) U.S. Cl. CPC G02B 6/0016; G02B 5/1809; G02B 27/0101

(57) ABSTRACT

The disclosed subject matter provides a coupling-in structure, a diffractive optical structure, and an optical display device. The coupling-in structure includes a substrate, and a coupling-in portion disposed on the substrate, wherein the coupling-in portion is configured to couple light into the substrate so that the light propagates within the substrate via total internal reflection. The coupling-in portion includes a coupling-in grating, a first film layer, and a second film layer that are stacked. The difference between the refractive index n₁ of the coupling-in grating and the refractive index n₂ of the first film layer satisfies: n₁−n₂≥0.3. The average coupling-in efficiency R₁ of the coupling-in grating for light is greater than 60%. After light is coupled into the interior of the substrate by the coupling-in grating, its average transmittance T₀ through the second film layer is less than 0.1%.

### CROSS-REFERENCE TO RELATED APPLICATION

This application claims priority to Chinese Patent Application No. 202411996420.X, filed on Dec. 31, 2024, which is hereby incorporated by reference in its entirety.

### TECHNICAL FIELD

Embodiments of the present application relate to the field of diffractive optical technology. More specifically, the embodiments of the present application relate to a coupling-in structure, a diffractive optical structure, and an optical display device.

### BACKGROUND

Augmented reality (AR) technology is a technology that integrates virtual information with the real world, and it has gradually demonstrated significant application potential across various industries. In the field of AR optical displays, the optical waveguide solution is regarded as one of the leading optical display solutions. Currently, optical waveguide solutions primarily include geometric waveguide schemes, surface relief grating waveguide schemes, and volume holographic waveguide schemes. Among these, the surface relief grating waveguide scheme has become the most extensively studied technical approach due to its balanced trade-off between fabrication complexity and optical performance.

However, existing surface relief grating waveguides, despite their advantages of small size and light weight, suffer from low optical propagation efficiency, which limits their application scenarios. The working principle of an AR optical waveguide is as follows: light is coupled into the waveguide substrate through a coupling-in region, propagates within the waveguide substrate via total internal reflection, and is then coupled out through an out-coupling region, allowing the human eye to perceive the virtual image projected by the AR optical engine. Therefore, the propagation efficiency of an AR optical waveguide is fundamentally determined by the coupling-in efficiency and the out-coupling efficiency. Since the out-coupling region requires pupil expansion, and in order to ensure uniformity of the pupil expansion, the out-coupling efficiency is difficult to significantly improve. Consequently, the efficiency of AR optical waveguides is predominantly determined by the coupling-in efficiency.

### SUMMARY

An object of the present application is to provide a new technical solution for a coupling-in structure, a diffractive optical structure, and an optical display device.

In a first aspect, the present application provides a coupling-in structure. The coupling-in structure includes a substrate and a coupling-in portion disposed on the substrate, wherein the coupling-in portion is configured to couple light into the substrate and enable the light to propagate within the substrate via total internal reflection;
wherein the coupling-in portion includes a coupling-in grating, a first film layer, and a second film layer that are stacked;
the first film layer has a transmittance greater than 95% in the visible light wavelength range;
the second film layer is a metal coating layer;
a difference between the refractive index n₁ of the coupling-in grating and the refractive index n₂ of the first film layer satisfies: n₁−n₂≥0.3;
the average coupling-in efficiency R1 of the coupling-in grating for light is greater than 60%; after light is coupled by the coupling-in grating into the substrate, its average transmittance T₀ through the second film layer is less than 0.1%; light that has already been coupled into the substrate and undergone total internal reflection, when encountering the coupling-in grating again, is capable of continuing to propagate via total internal reflection within the substrate, with an average efficiency R₀ of total internal reflection propagation greater than 50%.

Optionally, the refractive index n₁ of the coupling-in grating satisfies: 1.7≤n₁≤2.4

Optionally, in the thickness direction of the substrate, a ratio of a thickness h₂ of th first film layer to a grating depth h₁ of the coupling-in grating satisfies: 0.2≤h₂/h₁≤1.5.

Optionally, the thickness of the first film layer is h₂, and 1 nm≤h₂≤100 nm.

Optionally, the grating period T of the coupling-in grating satisfies: 200 nm≤T≤500 nm, and the grating depth h₁ of the coupling-in grating satisfies: 30 nm≤h₁≤400 nm.

Optionally, the first film layer is a non-metal coating layer, and the refractive index n₂ of the first film layer satisfies: 1.4≤n₂≤2.1.

Optionally, the material of the second film layer includes silver or aluminum.

Optionally, the thickness of the second film layer is h₃, and 60 nm≤h₃≤5 um.

Optionally, the coupling-in portion is a reflective coupling-in portion, wherein externally projected light is incident from one side of the substrate, and after being reflected by the coupling-in portion, enters the substrate to propagate via total internal reflection.

Optionally, the first film layer is stacked on the surface of the coupling-in grating that is opposite to the substrate;
the second film layer is stacked on the outer side of the first film layer.

In a second aspect, the present application provides a diffractive optical structure. The diffractive optical structure includes:
the coupling-in structure according to the first aspect; and
an out-coupling portion disposed on the substrate, wherein the out-coupling portion is configured to couple out light from the coupling-in portion.

In a third aspect, the present application provides an optical display device. The optical display device includes:
an optical engine; and
the diffractive optical structure according to the second aspect;
wherein the optical engine and the coupling-in portion are located on opposite sides of the substrate.

### ADVANTAGEOUS EFFECTS OF THE PRESENT APPLICATION

Embodiments of the present application provide a coupling-in structure for a diffractive optical structure. By combining a specially designed configuration of the coupling-in grating, the first film layer, and the second film layer (metal coating), and by appropriately designing the refractive index difference between the first film layer and the coupling-in grating, the coupling-in structure of the present application significantly improves the coupling-in efficiency of the diffractive optical structure compared to conventional coupling-in structures. For example, the coupling-in efficiency at the green light wavelength is improved by 30% to 140%, thereby effectively enhancing the optical efficiency of the diffractive optical structure. Due to the improved coupling-in efficiency, more light can be efficiently coupled into the substrate and propagate therein, which helps enhance the display performance of the diffractive optical structure, making the virtual image brighter and clearer, and thus improving the user's visual experience. Moreover, the coupling-in structure of the present application employs a simple stacked structural design, and achieves high coupling-in efficiency by controlling parameters such as the materials and refractive indices of the respective film layers.

Other features and advantages of the present application will become apparent from the following detailed description of exemplary embodiments of the present disclosure with reference to the accompanying drawings.

### BRIEF DESCRIPTION OF THE DRAWINGS

The drawings, which are incorporated herein and constitute a part of this specification, illustrate embodiments of the present disclosure and, together with the description, serve to explain the principles of the present disclosure.

FIG. 1 is a schematic structural diagram of the diffractive optical structure provided in an embodiment of the present application;

FIG. 2 is a comparison diagram of simulation results between the coupling-in portion according to an embodiment of the present application and coupling-in portions in comparative examples;

FIG. 3 is a schematic diagram illustrating the principle of light coupling into a conventional diffractive optical waveguide device.

### DESCRIPTION OF REFERENCE NUMERALS

1: substrate;
2: coupling-in portion; 21: coupling-in grating; 22: first film layer; 23: second film layer;
3: out-coupling portion;
4: optical engine.

### DETAILED DESCRIPTION

The various exemplary embodiments of the present application will now be described in detail with reference to the accompanying drawings. It should be noted that, unless otherwise specifically stated, the relative arrangements of components and steps, numerical expressions, and numerical values set forth in these embodiments are not to be construed as limiting the scope of the present application.

The following description of at least one exemplary embodiment is merely illustrative in nature and shall in no event be construed as any limitation on the present application, its applications, or its uses.

Technologies and devices known to those of ordinary skill in the relevant art may not be discussed in detail; however, where appropriate, such technologies and devices are to be considered as part of the specification.

In all examples illustrated and discussed herein, any specific value shall be interpreted as merely exemplary and not as restrictive. Therefore, other instances of the exemplary embodiments may have different values.

It should be noted that like reference numerals and letters refer to similar items in the following drawings, and thus, once an item is defined in one drawing, it may not be further discussed in subsequent drawings.

Hereinafter, the coupling-in structure, the diffractive optical structure, and the optical display device provided by the embodiments of the present application will be described in detail with reference to the accompanying drawings.

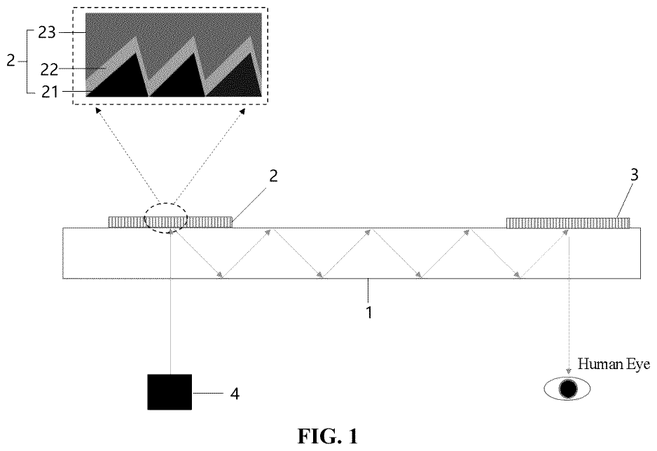

According to an embodiment of the present application, a coupling-in structure is provided. Referring to FIG. 1, the coupling-in structure is applied to a diffractive optical structure.

The coupling-in structure according to the embodiment of the present application, as shown in FIG. 1, includes a substrate 1 and a coupling-in portion 2 disposed on the substrate 1. The coupling-in portion 2 is configured to couple light into the substrate 1 and includes a coupling-in grating 21, a first film layer 22, and a second film layer 23 that are stacked. The first film layer 22 has a transmittance greater than 95% in the visible light wavelength range. The second film layer 23 is a metal coating layer. A difference between a refractive index n₁ of the coupling-in grating 21 and a refractive index n₂ of the first film layer 22 satisfies: n₁−n₂≥0.3.

An average coupling-in efficiency R₁ of the coupling-in grating 21 for light is greater than 60%. After the light is coupled by the coupling-in grating 21 into the substrate 1, an average transmittance T₀ of the light through the second film layer 23 is less than 0.1%. Light that has been coupled into the substrate 1 and has undergone total internal reflection, when encountering the coupling-in grating 21 again, is capable of continuing to propagate via total internal reflection within the substrate 1, wherein an average efficiency R₀ of the total internal reflection propagation is greater than 50%.

The coupling-in structure provided in this embodiment of the present application is specifically designed for a coupling-in portion of a diffractive optical structure. The diffractive optical structure may be, for example, a diffractive optical waveguide device, which finds broad applicability in fields such as AR (Augmented Reality) optical displays, and may also be used in other optical display fields such as VR (Virtual Reality).

The coupling-in structure provided in this embodiment of the present application aims to address the issue of low coupling-in efficiency in conventional devices such as diffractive optical waveguides. The solution offered by the coupling-in structure of this embodiment can significantly improve the coupling-in efficiency of the diffractive optical structure, thereby enhancing its overall optical efficiency.

Referring to FIG. 1, the coupling-in structure provided in the embodiment of the present application includes a substrate 1 and a coupling-in portion 2; wherein the substrate 1 serves as the foundation of the entire coupling-in structure and is configured to support the overall architecture.

With respect to the substrate 1 provided in the present application, the material of the substrate 1 may be any one of glass, resin, lithium niobate, silicon carbide, or the like, as these materials exhibit good optical properties and stability.

The coupling-in portion 2 provided in the present application is responsible for coupling light into the interior of the substrate 1, and it is a key component for enabling display in a diffractive optical structure (such as a diffractive optical waveguide device). The coupling-in portion 2 is capable of coupling light used for imaging and display into the substrate 1 and enabling the light to propagate within the substrate 1 via total internal reflection.

The coupling-in portion 2 provided in the present application includes a coupling-in grating 21, which, for example, is directly disposed on the substrate 1, and serves as one of the core optical components of the coupling-in portion 2.

In addition to the aforementioned coupling-in grating 21, the coupling-in portion 2 provided in the present application further includes a first film layer 22 and a second film layer 23; the first film layer 22 may be used to modulate the light coupling process. It should be noted that the refractive index n₁ of the coupling-in grating 21 and the refractive index n₂ of the first film layer 22 are designed with a certain difference, and this design enables effective coupling of light.

In the coupling-in structure provided in the embodiment of the present application, the refractive index difference (n₁−n₂) between the coupling-in grating 21 and the first film layer 22 is a critical parameter, which directly affects the coupling efficiency of light from the coupling-in grating 21 to the first film layer 22.

The coupling-in portion 2 provided in the embodiment of the present application also includes a second film layer 23, wherein the second film layer 23 is a metal coating layer. The metal coating layer introduced in the present application has excellent reflective properties, effectively preventing incident light from undergoing unexpected diffraction or escaping within the coupling-in portion 2, thus ensuring efficient transmission of optical energy. Therefore, the addition of the second film layer 23 becomes one of the key factors for enhancing coupling-in efficiency, promoting efficient coupling of light into the substrate 1. As such, the introduction of this second film layer 23 can further enhance coupling-in efficiency, ensuring that light is efficiently coupled into the substrate 1.

Moreover, the second film layer 23, which is a metal coating layer, also serves to protect the coupling-in grating 21, effectively safeguarding it against potential damage from external environments, thereby contributing to the extended lifespan and stability of the entire coupling-in structure.

In the coupling-in structure of the present application, the refractive index difference (n₁−n₂) between the coupling-in grating 21 and the first film layer 22 is another critical parameter that directly affects the coupling efficiency of light from the coupling-in grating 21 to the first film layer 22. In the present application, the refractive index of the coupling-in grating 21 is greater than that of the first film layer 22, with their refractive index difference being greater than 0.3.

Preferably, the refractive index difference is greater than 0.4.

If the refractive index difference between the coupling-in grating 21 and the first film layer 22 is less than 0.3, the following drawbacks may occur:
(1) Lower Coupling Efficiency: If the refractive index difference (n₁−n₂) is small, for instance less than 0.3, this means that when light transitions from the coupling-in grating 21 to the first film layer 22, its direction change will not be significant enough, resulting in some light failing to be effectively coupled into the substrate 1. This would lead to reduced coupling efficiency, thereby affecting the optical performance of the diffractive optical structure.
(2) Unstable Optical Performance: A smaller refractive index difference, such as less than 0.3, might increase the sensitivity of the diffractive optical structure to the angle of incidence of light. When there is a slight change in the angle of incidence, the coupling efficiency could fluctuate significantly, leading to unstable optical performance.

Designing the refractive index difference (n₁−n₂) between the coupling-in grating 21 and the first film layer 22 to be greater than or equal to 0.3 in the present application can significantly improve coupling efficiency. This is because: when light enters from the coupling-in grating 21, the larger the refractive index difference, the more pronounced the directional change of light upon entering the first film layer 22. Such a pronounced directional change facilitates more effective coupling of light into the substrate 1, reducing reflection and scattering losses, thereby improving coupling efficiency.

Additionally, a larger refractive index difference increases the tolerance of the coupling-in structure to variations in the angle of incidence. Even if there are slight changes in the angle of incidence, the coupling efficiency can remain relatively stable, offering better adaptability to changes in the angle of incidence in practical applications.

In summary, controlling the refractive index difference to be greater than or equal to 0.3 in the present application is very reasonable, as this choice helps to enhance coupling efficiency and strengthen the stability of optical performance.

Regarding the design of the first film layer 22, its high transmittance in the visible light wavelength range—specifically, a transmittance greater than 95%—delivers the following significant technical effects:
(1) Improved Light Utilization: The high transmittance of the first film layer 22 in the visible spectrum means that the majority of incident light can pass through this layer unimpeded, thereby effectively interacting with the coupling-in grating 21. This significantly enhances light utilization, enabling more light to be efficiently coupled into the substrate 1 for propagation via total internal reflection.
(2) Enhanced Visual Quality: Since visible light constitutes the primary component of human visual perception, the high transmittance of the first film layer 22 helps ensure that virtual images rendered by a diffractive optical structure incorporating the coupling-in structure of the present application exhibit sharp clarity and vivid color fidelity. This is crucial for delivering an improved user viewing experience.

By designing the first film layer 22 with high transmittance, the present application not only improves light utilization and visual quality but also enhances the overall reliability and stability of the coupling-in structure.

The coupling-in structure provided in the embodiment of the present application significantly improves the coupling-in efficiency of the diffractive optical structure.

Moreover, the coupling-in structure satisfies the following relationships:
the average coupling-in efficiency R₁ of the coupling-in grating 21 for light is greater than 60%; after light is coupled by the coupling-in grating 21 into the substrate 1, its average transmittance T₀ through the second film layer 23 is less than 0.1%; and light that has already been coupled into the substrate 1 and undergone total internal reflection, when encountering the coupling-in grating 21 again, is capable of continuing to propagate via total internal reflection within the substrate 1, with an average efficiency R₀ of total internal reflection propagation greater than 50%.

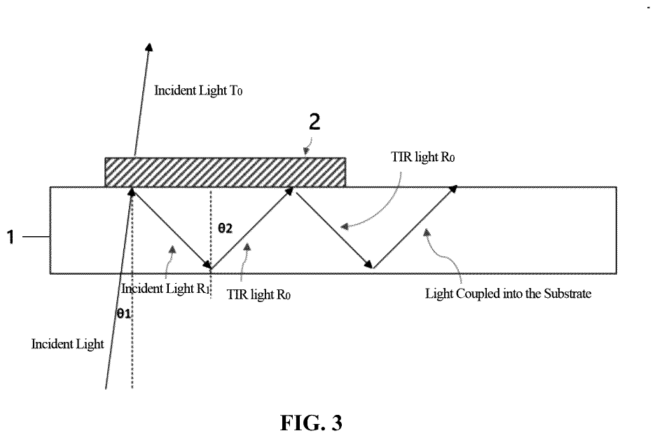

Referring to FIG. 3, the average coupling-in efficiency R₁>60% represents the efficiency with which light is coupled by the coupling-in grating 21 into the substrate 1. Specifically, the average coupling-in efficiency R₁ represents the diffraction order of the incident light that is initially diffracted into the total internal reflection propagation regime within substrate 1, namely, the first-order diffraction. Coupling-in efficiency is one of the key metrics for evaluating the performance of a diffractive optical structure. A higher coupling-in efficiency means that more light is effectively directed into the waveguide, thereby enhancing the overall optical efficiency of the diffractive optical structure.

Still referring to FIG. 3, after being coupled by the coupling-in grating 21 into the substrate 1, the light exhibits an average transmittance T₀<0.1% when passing through the second film layer 23. This parameter reflects the transmittance of light through the second film layer 23 (a metal coating layer) after it has entered the substrate 1. T₀ quantifies the unintended transmission loss at this stage; since such transmission represents undesirable optical leakage, it is expressed as a very low percentage. In the present application, the transmittance of the second film layer 23 directly impacts optical loss—lower transmittance ensures minimal leakage and thus helps maintain high optical efficiency.

Continuing with reference to FIG. 3, light that has already been coupled into the substrate 1 and propagated via total internal reflection, upon encountering the coupling-in grating 21 again, can continue propagating via total internal reflection within the substrate 1 with an average efficiency R₀>50%. This parameter indicates the efficiency with which light, after undergoing total internal reflection inside the substrate 1, maintains guided propagation when re-interacting with the coupling-in grating 21. Specifically, R₀ corresponds to the zero-order reflection efficiency at the grating, which allows light to remain confined within the waveguide without being out-coupled or scattered. The efficiency of total internal reflection propagation is a critical indicator of the stability and robustness of a diffractive optical structure. A higher R₀ value signifies more stable in-waveguide propagation with reduced loss and interference.

These three parameters—R₁, T₀, and R₀—together reflect the optical performance and stability of the coupling-in structure disclosed herein. By optimizing these parameters, the overall optical efficiency and functional effectiveness of the coupling-in structure are significantly enhanced.

Embodiments of the present application provide a coupling-in structure for use in a diffractive optical structure. Through the synergistic design of the coupling-in grating 21, the first film layer 22, and the second film layer 23 (metal coating), along with a deliberate refractive index difference between the first film layer 22 and the coupling-in grating 21, the coupling-in structure of the present application achieves substantially higher coupling-in efficiency compared to conventional designs—for example, an improvement of 30% to 140% in coupling efficiency at green wavelengths. This effectively boosts the overall optical efficiency of the diffractive optical structure. As a result of this enhanced coupling-in efficiency, more light is efficiently coupled into the substrate 1 and propagates therein, leading to brighter and clearer virtual images and an improved visual experience for the user. Furthermore, the coupling-in structure employs a simple stacked architecture, and by precisely controlling material selection, refractive indices, and other parameters of the individual film layers, it achieves highly efficient light coupling.

In some examples of the present application, the refractive index n₁ of the coupling-in grating 21 satisfies: 1.7≤n₁≤2.4.

This example specifies that the refractive index n₁ of the coupling-in grating 21 falls within the range of 1.7 to 2.4. Given the earlier requirement that the refractive index of the coupling-in grating 21 is greater than that of the first film layer 22, and that their refractive index difference exceeds 0.3, this design choice is not arbitrary. The following provides an analysis of the rationale behind selecting this refractive index range for the coupling-in grating 21 and its associated technical benefits.

By setting the refractive index of the coupling-in grating 21 within the range specified in this example, the present application ensures diversity and availability in the material selection for the first film layer 22, thereby providing convenience for manufacturing.

In some examples of the present application, in the thickness direction of the substrate 1, the ratio of the thickness h₂ of the first film layer 22 to the grating depth h₁ of the coupling-in grating 21 satisfies: 0.2≤h₂/h₁≤1.5.

By precisely controlling the ratio between h₂ and h₁, the diffraction behavior of light during the coupling process can be more effectively managed. This helps ensure that a greater proportion of incident light is coupled into the substrate 1 as intended for total internal reflection propagation, thereby improving coupling-in efficiency.

An appropriately designed thickness for the first film layer 22 not only enhances optical performance but also provides better physical protection for the coupling-in grating 21, improving structural robustness. This helps mitigate adverse effects from external environmental factors—such as thermal fluctuations and mechanical stress—on the coupling-in grating 21, thus extending the operational lifetime of the entire coupling-in structure.

Moreover, by defining the thickness ratio range between the first film layer 22 and the coupling-in grating 21, this example offers practical guidance for the fabrication process of the coupling-in architecture disclosed herein. This contributes to consistent achievement of target optical performance across manufactured units, enhancing both manufacturing precision and repeatability.

Furthermore, controlling the dimensional relationship between the thicknesses of the first film layer 22 and the coupling-in grating 21 enables effective enhancement of coupling-in efficiency while simultaneously improving the structural stability and manufacturability of the coupling-in structure.

In some examples of the present application, the thickness h₂ of the first film layer 22 satisfies: 1 nm≤h₂≤100 nm.

Within this 1 nm to 100 nm range, the thickness of the first film layer 22 exerts an optimal influence on the coupling process of light from the coupling-in grating 21 into the substrate 1.

This specific thickness design of the first film layer 22, as provided in this example, helps minimize unwanted reflection and scattering, enabling light to be more efficiently guided into the substrate 1, thereby increasing coupling-in efficiency. The improved coupling-in efficiency directly translates into enhanced image quality. Consequently, within the 1 nm to 100 nm thickness range, the first film layer 22 ensures that virtual images appear brighter and sharper. Additionally, the thickness range of the first film layer 22 in this example does not significantly increase the overall dimension of the coupling-in structure in the thickness direction.

If the thickness of the first film layer 22 is less than 1 nm, it may be unable to provide sufficient mechanical strength and optical performance to support effective light coupling. Moreover, an excessively thin first film layer 22 may be difficult to control precisely during manufacturing, leading to unstable performance. From an optical perspective, an overly thin first film layer 22 may fail to generate sufficient phase retardation to guide light into the waveguide, thereby significantly reducing coupling-in efficiency.

When the thickness of the first film layer 22 exceeds 100 nm, it may introduce excessive absorption and scattering losses, causing significant attenuation of light during the coupling process. This likewise reduces coupling-in efficiency and adversely affects the brightness and clarity of the AR image. Additionally, an overly thick first film layer 22 may increase manufacturing cost and complexity due to longer coating times and greater material consumption.

In some examples of the present application, the grating period T of the coupling-in grating 21 satisfies: 200 nm≤T≤500 nm, and the grating depth h₁ of the coupling-in grating 21 satisfies: 30 nm≤h₁≤400 nm.

The grating period of the coupling-in grating 21 provided in the embodiment of the present application is one of the key factors affecting diffraction efficiency. Within the range of 200 nm to 500 nm, the grating period enables good matching with the wavelength of incident light, allowing light to undergo effective diffraction as it passes through the coupling-in grating 21, and thereby be efficiently coupled into the substrate 1.

The selection of this grating period range in the example also helps broaden the spectral response of the coupling-in structure. Light of different wavelengths can experience varying degrees of diffraction when passing through a grating with an appropriate period, thus enabling effective coupling across a wide spectral range.

By optimizing the grating period, coupling-in efficiency can be improved, which in turn enhances the brightness and clarity of the AR image. This contributes to an improved user visual experience, particularly in complex lighting conditions or applications requiring high-definition display.

The depth of the coupling-in grating 21 is an important factor influencing the balance between diffraction and reflection. Within the range of 30 nm to 400 nm, this grating depth appropriately balances diffraction and reflection, enabling more light to be effectively coupled into the substrate 1.

In the present application, the coupling-in grating 21 is, for example, a one-dimensional grating.

One-dimensional gratings offer advantages such as simple structure and ease of fabrication, and provide high diffraction efficiency in a specific direction. By optimizing the period and depth of the one-dimensional grating, its one-dimensional diffraction characteristics can be further enhanced, thereby achieving more efficient light coupling.

In some examples of the present application, the first film layer 22 is a non-metal coating layer, and the refractive index n₂ of the first film layer 22 satisfies: 1.4≤n₂≤2.1.

In this example, the first film layer 22 is a non-metal coating layer. When its thickness is within the range of 1 nm to 100 nm, the coating process for the first film layer 22 is relatively easy to control, ensuring consistent performance of the manufactured coupling-in structures.

In this example, the refractive index range of the first film layer 22 is specifically designed. Within the disclosed refractive index range, a suitable refractive index difference is achieved between the first film layer 22 and the coupling-in grating 21, thereby optimizing the light coupling process at the interface between them. Light can be more effectively directed into the substrate 1, reducing reflection and scattering losses and thus improving coupling-in efficiency. The improved coupling-in efficiency directly enhances image quality—since more light is efficiently coupled into the substrate 1, the virtual image becomes brighter and clearer, significantly improving the user's visual experience.

Due to the enhanced coupling-in efficiency, the coupling-in structure provided in the embodiment of the present application is suitable for a wider range of application scenarios with complex lighting conditions. For example, it can deliver stable image display performance both under strong outdoor sunlight and in dim indoor environments.

In some examples of the present application, the material of the second film layer 23 includes silver or aluminum.

In this example, the second film layer 23 is made of silver or aluminum. Silver and aluminum exhibit excellent reflectivity, effectively reflecting light from the coupling-in grating 21 back into the substrate 1, thereby minimizing optical loss and improving coupling-in efficiency. This helps enhance the brightness and clarity of the AR image, further improving the user's visual experience.

Metals exhibit high hardness and wear resistance, enabling them to withstand erosion and abrasion from the external environment. This allows the second film layer 23 to maintain stable performance over long-term use, thereby extending the service life of the diffractive optical structure.

In addition, silver and aluminum are both excellent electrical conductors, which facilitates the implementation of functions such as electromagnetic shielding and electrostatic protection in diffractive optical structures or AR optical display devices.

Silver and aluminum also demonstrate good compatibility with a variety of materials, making them easy to integrate with other film layers or structural components. Moreover, these metals can be readily processed using standard thin-film deposition techniques such as physical vapor deposition (PVD) and chemical vapor deposition (CVD), which supports mass production.

In some examples of the present application, the thickness h₃ of the second film layer 23 satisfies: 60 nm≤h₃≤5 um.

In the coupling-in structure provided herein, the second film layer 23 serves as a reflective layer, and its thickness directly affects reflectivity. Within the range of 60 nm to 5 μm specified in this example, metal coatings such as silver or aluminum can form continuous and uniform films, effectively reflecting light back into the substrate 1, minimizing optical loss, and thereby improving coupling-in efficiency.

In AR applications, displayed images often contain light across multiple wavelengths. Within the 60 nm to 5 μm thickness range, the metallic second film layer 23 maintains relatively stable reflectivity across different wavelengths, ensuring accurate color reproduction and image clarity.

Furthermore, within this thickness range, the second film layer 23 can be fabricated using various thin-film deposition techniques—such as PVD and CVD—which offer high precision, stability, and repeatability, ensuring uniformity and consistency in film thickness.

An adequate thickness of the second film layer 23 also provides better mechanical support, enhancing the overall structural stability and durability of the coupling-in structure. This helps mitigate the impact of external environmental factors—such as temperature and humidity—on film performance, further prolonging the lifespan of the diffractive optical structure.

It should be noted that the thickness of the second film layer 23 is directly related to material consumption. An excessively thick layer increases material cost, particularly when precious metals like silver are used. The deposition process also requires time and energy; thus, an overly thick second film layer 23 leads to longer processing times and higher energy consumption. For diffractive optical structures, lightweight and compact design are key development trends, and an unnecessarily thick second film layer 23 would undesirably increase the weight and volume of the device.

In some examples of the present application, the coupling-in portion 2 is a reflective-type coupling-in portion. Externally projected light enters from one side of the substrate 1, is reflected by the coupling-in portion 2, and then propagates within the substrate 1 via total internal reflection.

In this example, a coupling-in structure for a diffractive optical structure is provided, wherein the coupling-in portion 2 is designed as a reflective-type coupler. This configuration allows externally incident light to enter from one side of the substrate 1, be reflected by the coupling-in portion 2, and then undergo total internal reflection propagation inside the substrate 1. The reflective design of the coupling-in portion 2 enables efficient redirection of most incident light into the substrate 1, minimizing direct transmission or scattering losses. This improves light utilization, allowing more light to participate in the subsequent display process, thereby enhancing image brightness and contrast.

In some examples of the present application, the coupling-in grating 21 includes a rectangular grating, blazed grating, trapezoidal grating, or multi-step (stepped) grating. A notable feature of the coupling-in structure disclosed herein is its compatibility with various grating types. This adaptability allows the structure to flexibly meet diverse application requirements—for instance, blazed or stepped gratings may be selected in scenarios demanding high diffraction efficiency, while rectangular or trapezoidal gratings may be preferred when ease of fabrication is a priority.

In some examples of the present application, as shown in FIG. 1, the first film layer 22 is stacked on the surface of the coupling-in grating 21 that faces away from the substrate 1; the second film layer 23 is further stacked on the outer side of the first film layer 22.

According to this example, the first film layer 22 is stacked on the coupling-in grating 21, and the second film layer 23 is disposed on the outer side of the first film layer 22 —that is, the side farthest from both the substrate 1 and the coupling-in grating 21. This arrangement forms a multi-layer coupling-in structure, with each layer performing a specific function.

The coupling-in grating 21: As the key component for directing light into the substrate 1, the coupling-in grating 21 achieves effective diffraction and coupling of incident light through the design of its optical parameters, such as period and depth. Optimization of its material refractive index and structural parameters ensures that light can enter the substrate 1 with high efficiency.

The first film layer 22: Its primary role is to further enhance coupling-in efficiency and optimize light propagation within the substrate 1. By selecting appropriate materials (e.g., those with a refractive index in the range of 1.4 to 2.1) and coating methods, the first film layer 22 improves light transmittance and reduces optical loss.

The second film layer 23: Formed as a metal coating (e.g., silver or aluminum), it serves mainly as a reflector and protective layer. It effectively reflects light that has not been coupled-in back toward the substrate 1, thereby improving overall light utilization. Additionally, the metal coating protects the underlying first film layer 22 and coupling-in grating 21 from environmental damage.

Through the synergistic interaction between the coupling-in grating 21 and the first film layer 22, the coupling-in structure in this example significantly enhances light coupling-in efficiency. This design not only optimizes the diffraction and coupling processes but also minimizes light loss and scattering.

Regarding the arrangement of the first film layer 22 and the second film layer 23 —particularly the reflective function of the second film layer 23—it ensures stable propagation of light within the substrate 1. This helps reduce fluctuations and attenuation during propagation, thereby improving the stability and clarity of the displayed image.

By optimizing the structure and material parameters of each layer, the coupling-in architecture in this example enables precise control over the light propagation path. This not only boosts coupling-in efficiency but also refines the propagation characteristics of light within the substrate 1, contributing to enhanced overall performance of the diffractive waveguide device.

In some examples of the present application, the substrate 1 is made of one of the following materials: glass, resin, lithium niobate, or silicon carbide.

Glass offers excellent transparency, superior optical performance, and high stability, and can withstand moderate temperature variations. It is suitable for optical devices with stringent requirements on transparency and optical quality.

Resin is characterized by low cost, ease of molding, and lightweight properties, making it ideal for applications where weight and manufacturing cost are critical constraints.

Lithium niobate exhibits outstanding electro-optic effects and is well suited for optical devices requiring high-speed electro-optic modulation.

Silicon carbide features high hardness, wear resistance, and good thermal and electrical conductivity. It is suitable for optical devices that require high durability and thermal stability.

Different substrate materials have different effects on light transmission and diffraction. By selecting an appropriate substrate material according to actual needs, light transmission efficiency can be optimized, light loss reduced, and the overall optical performance of optical devices—such as diffractive optical structures—improved.

The design of the coupling-in structure in the present application achieves precise control over the light propagation path by optimizing parameters of the coupling-in grating 21 —including its refractive index, period, and depth—and by appropriately arranging the first film layer 22 and the second film layer 23, thereby achieving the goal of improving coupling-in efficiency. This design concept and technical solution provide new ideas and approaches for the development of diffractive optical structure technology.

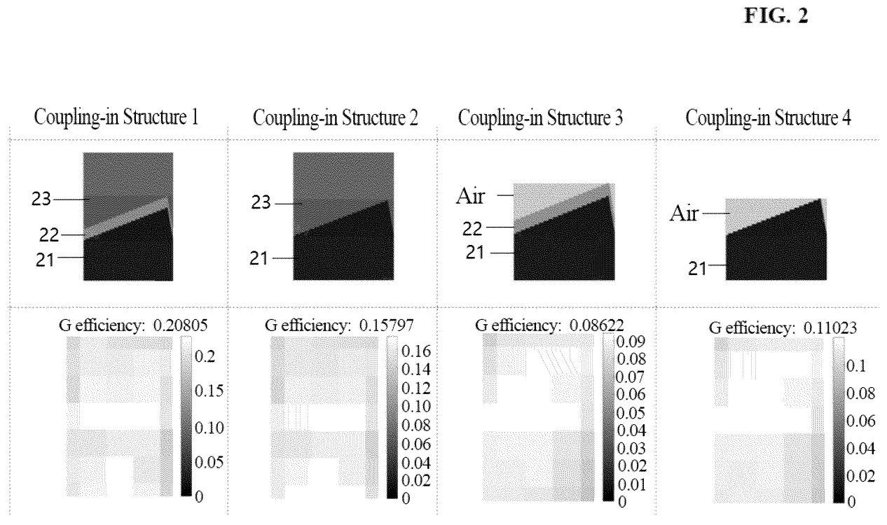

Referring to FIG. 2, performance verification of the coupling-in structure for diffractive optical structures proposed in the embodiment of the present application was carried out through simulation experiments. This section describes in detail the coupling-in efficiencies of four coupling-in structures for green light in the visible spectrum and provides a comparative analysis, as follows:

### I. Simulation Experiment Setup

Experiment objective: To verify that the coupling-in structure proposed in the present application (defined as Coupling-in Structure One in the experiment) achieves improved coupling-in efficiency for green light compared to other comparative coupling-in structures.

### Experiment Architecture:

Coupling-in Structure One: includes the coupling-in grating 21, the first film layer 22 disposed on the coupling-in grating 21, and the second film layer 23 disposed on the outer side of the first film layer 22—that is, the coupling-in structure of the present application.

Coupling-in Structure Two: includes the coupling-in grating 21 and the second film layer 23 disposed directly on the coupling-in grating 21—that is, Comparative Structure One.

Coupling-in Structure Three: includes the coupling-in grating 21 and the first film layer 22 disposed directly on the coupling-in grating 21—that is, Comparative Structure Two.

Coupling-in Structure Four: includes only the coupling-in grating 21—that is, Comparative Structure Three.

### Experiment Conditions:

Green light was used as the test light source, and simulations were performed to model the light transmission and diffraction processes under the different coupling-in structures.

### II. Simulation Results Show

### Coupling-in Efficiency:

Coupling-in Structure One (the coupling-in structure of the present application): the coupling-in efficiency for green light is 20.6%.

Coupling-in Structure Two (Comparative Structure One): the coupling-in efficiency for green light is 15.8%.

Coupling-in Structure Three (Comparative Structure Two): the coupling-in efficiency for green light is 8.6%.

Coupling-in Structure Four (Comparative Structure Three): the coupling-in efficiency for green light is 11%.

### III. Comparative Analysis

### Efficiency Improvement:

Compared with Coupling-in Structure Two, the green light coupling-in efficiency of Coupling-in Structure One is improved by (20.6%−15.8%)/15.8% ≈30%.

Compared with Coupling-in Structure Three, the green light coupling-in efficiency of Coupling-in Structure One is improved by (20.6%−8.6%)/8.6% ≈140%.

Compared with Coupling-in Structure Four, the green light coupling-in efficiency of Coupling-in Structure One is improved by (20.6%−11%)/11% ≈87%.

Overall, the coupling-in structure provided in the embodiment of the present application (Coupling-in Structure One) significantly improves the coupling-in efficiency for green light by introducing both the first film layer 22 and the second film layer 23. Compared with other comparative structures, the coupling-in structure of the present application demonstrates a clear advantage in optical efficiency, which is beneficial for enhancing the overall performance of AR diffractive optical structures.

In summary, simulation experiments have verified that the coupling-in structure proposed in the present application achieves a significant improvement in green light coupling-in efficiency compared to other comparative structures. This result indicates that the proposed coupling-in structure can substantially increase the coupling-in efficiency of diffractive optical structures (such as diffractive waveguide devices), thereby improving the optical efficiency of the waveguide and providing strong technical support for the application and development of AR technology.

It should be noted that the coupling-in structure proposed in the present application also shows significant improvements in red light and blue light coupling-in efficiencies compared to other comparative structures; detailed descriptions thereof are omitted herein.

According to another embodiment of the present application, a diffractive optical structure is provided. Referring to FIG. 1, the diffractive optical structure includes: the aforementioned coupling-in structure and an out-coupling portion 3, wherein the out-coupling portion 3 is disposed on the substrate 1 and is configured to couple out light received from the coupling-in portion 2.

The diffractive optical structure of the present application mainly consists of two parts: the coupling-in structure and the out-coupling portion 3. The coupling-in structure has been described above and includes the substrate 1, the coupling-in grating 21, the first film layer 22, and the second film layer 23. The coupling-in portion 2 is configured to efficiently couple light into the substrate 1 for total internal reflection propagation. The out-coupling portion 3 is disposed on the substrate 1 and is primarily configured to couple out the light from the coupling-in portion 2 so that the human eye can view the virtual image projected by the optical engine 4.

The out-coupling portion 3 may be an out-coupling grating, which may be a one-dimensional grating, a two-dimensional grating, or the like. A one-dimensional grating features a simple structure and lower fabrication cost, whereas a two-dimensional grating may provide more complex diffraction effects in certain application scenarios.

According to yet another embodiment of the present application, an optical display device is provided. The optical display device includes an optical engine 4 and the aforementioned diffractive optical structure, wherein the optical engine 4 and the coupling-in portion 2 are located on opposite sides of the substrate 1.

The optical engine 4 is one of the core components of the optical display device and is responsible for generating and projecting the light required for the virtual image. In the embodiment of the present application, the optical engine 4 is positioned on one side of the substrate 1, opposite to the coupling-in portion 2. Thus, light emitted by the optical engine 4 can directly illuminate the coupling-in portion 2, enabling efficient light coupling.

The diffractive optical structure: As described above, the diffractive optical structure includes the coupling-in structure and the out-coupling portion 3. The coupling-in structure is configured to efficiently couple the light emitted by the optical engine 4 into the substrate 1, while the out-coupling portion 3 is configured to couple the light out of the substrate 1 to form a virtual image visible to the human eye. These two parts work together to achieve efficient light transmission and display.

The optical display device provided in the embodiment of the present application has broad application prospects. For example, in the field of augmented reality (AR), it can serve as a core component of AR glasses or headsets, providing users with a more realistic and immersive virtual experience. Additionally, the optical display device also holds potential application value in virtual reality (VR), mixed reality (MR), and other related fields.

Specific implementations of the optical display device according to the present application can refer to the various embodiments of the coupling-in structure and the diffractive optical structure described above; therefore, it at least possesses all the beneficial effects brought about by the technical solutions of the aforementioned embodiments, and further description thereof is omitted herein for brevity.

The foregoing embodiments primarily emphasize the differences among the respective embodiments. Optimization features that differ among the embodiments may be combined to form even better embodiments, provided they are not mutually contradictory. For the sake of conciseness, such combinations are not reiterated herein.

Although specific embodiments of the present application have been described in detail above by way of example, those skilled in the art will understand that the examples are provided for illustration only and are not intended to limit the scope of the present application. Those skilled in the art will further appreciate that modifications may be made to the above embodiments without departing from the scope and spirit of the present application. The scope of the present application is defined by the appended claims.

1. A coupling-in structure, comprising a substrate and a coupling-in portion disposed on the substrate, wherein the coupling-in portion is configured to couple light into the substrate so that the light propagates within the substrate via total internal reflection;
wherein the coupling-in portion comprises a coupling-in grating, a first film layer, and a second film layer that are stacked;
wherein the first film layer has a visible light wavelength transmittance greater than 95%;
wherein the second film layer comprises a metal coating layer;
wherein a difference between a refractive index n₁ of the coupling-in grating and a refractive index n₂ of the first film layer satisfies n₁−n₂≥0.3;
wherein an average coupling-in efficiency R₁ of the coupling-in grating for the light is greater than 60%;
wherein after the light is coupled by the coupling-in grating into the substrate, an average transmittance T₀ of the light through the second film layer is less than 0.1%; and
further configured such that the light that has been coupled into the substrate and undergone total internal reflection, when encountering the coupling-in grating again, propagates via total internal reflection within the substrate, with an average efficiency R₀ of total internal reflection propagation greater than 50%.

2. The coupling-in structure according to claim 1, wherein the refractive index n₁ of the coupling-in grating satisfies: 1.7≤n₁≤2.4.

3. The coupling-in structure according to claim 1, wherein, along a thickness direction of the substrate, a ratio of a thickness h₂ of the first film layer to a grating depth h₁ of the coupling-in grating satisfies: 0.2≤h₂/h₁≤1.5.

4. The coupling-in structure according to claim 3, wherein a thickness of the first film layer is h₂, and 1 nm≤h₂≤100 nm.

5. The coupling-in structure according to claim 3, wherein a grating period T of the coupling-in grating satisfies: 200 nm≤T≤500 nm, and a grating depth h₁ of the coupling-in grating satisfies: 30 nm≤h₁≤400 nm.

6. The coupling-in structure according to claim 1, wherein the first film layer comprises a non-metal coating layer, and a refractive index n₂ of the first film layer satisfies: 1.4≤n₂≤2.1.

7. The coupling-in structure according to claim 1, wherein a material of the second film layer comprises silver or aluminum.

8. The coupling-in structure according to claim 7, wherein a thickness of the second film layer is h₃, and 60 nm≤h₃≤5 um.

9. The coupling-in structure according to claim 1, wherein the coupling-in portion comprises a reflective coupling-in portion, wherein externally projected light is incident from one side of the substrate, and after being reflected by the coupling-in portion, enters the substrate to propagate via total internal reflection.

10. The coupling-in structure according to claim 1, wherein the first film layer is stacked on a surface of the coupling-in grating that is opposite to the substrate; and
the second film layer is stacked on an outer side of the first film layer.

11. A diffractive optical structure, comprising:
the coupling-in structure according to claim 1; and
an out-coupling portion disposed on the substrate, wherein the out-coupling portion is configured to couple out light from the coupling-in portion.

12. An optical display device, comprising:
an optical engine; and
the diffractive optical structure according to claim 11;
wherein the optical engine and the coupling-in portion are disposed on opposite sides of the substrate.
